(19) United States
(12) Patent Application Publication
(10) Pub. No.: US 2026/0281251 A1
(43) Pub. Date: Sep. 17, 2026

(54) Cell Phone Travel Application (APP) to Replace Hotel Guest Room Push Button Phones

(71) Applicant: Douglas J. Killion, Long Beach, CA (US)

(72) Inventor: Douglas J. Killion, Long Beach, CA (US)

(21) Appl. No.: 19/081,476

(22) Filed: Mar. 17, 2025

(51) Int. Cl. H04M 7/00; G06F 16/955; G06Q 50/12

(52) U.S. Cl. CPC H04M 7/006; G06F 16/955; G06Q 50/12

(57) ABSTRACT

A cell phone travel app for hotel guests to download onto their personal cell phones allowing communication with hotel staff and hotel services using mobile cellular and web-based technology. A system which includes software that allows hotels to generate QR codes with phone, web and navigation links specific to each hotel location/address. A cell phone app that hotel guests use to scan QR codes in their guest rooms to load hotel service-related phone, web and navigation links onto their cell phone screens. A technology that combined with existing cell phone technology supplants the need for guest room push button phone technology and allows hotels to remove push button phones and associated PBX or VOIP phone service from guest rooms.

### FIELD

This patent application is for a mobile cell phone travel application (App) software system that allows hotel guest cell phones to replace and enhance the functionality of hotel guest room push button phone communication systems.

### BACKGROUND

Guest room push button phone technologies used by hotels (e.g. hotels, motels, resorts, bed and breakfasts, etc.) are becoming outdated. These technologies include multi-line private branch exchange (PBX) phone systems developed in the 1930's, push button phones developed in the 1960's, and multi-line voice over internet protocol (VOIP) phone systems developed in the 1970's. All of these technologies developed before cell phone technology gained widespread usage beginning in the 2000's. It is estimated that 75% of hotels still use analog PBX phone systems. Initially, the purpose of hotel guest room push button phones was to allow guests to make local and long-distance calls from their rooms. Speed dial buttons were added to connect with hotel services (front desk, housekeeping, room service, valet, etc.). Push button hotel phones also provide messaging, wake-up, and emergency 911 call functionality. There currently are no cellular applications or other technologies that would transform hotel guest cell phones into mobile guest room phones for use during hotel stays.

The use of hotel guest room push button phones has decreased dramatically with the advent of cell phone technology. Hotel guests use their cell phones to make local and long-distance calls and to receive messages. Hotel guests use their cell phone clock alarm function to wake up. Cell phones have emergency 911 functionality built into their design. What is missing from guest cell phones is speed dial phone links for hotel services. Additionally, guests need easy access to hotel web links to schedule appointments, place orders, and search for information related to their hotel stay. Hotel Phone App™ provides these functions to allow guest cell phones to replace the functionality of guest room push button phones. The addition of Hotel Phone App™ for guests to use on their personal cell phones supplants the need for hotels to maintain push button phones and VOIP or PBX services for hotel guest rooms.

Hotels determine which phone and web links to install on Hotel Phone App™ and these can be updated at any time. Phone and web links are entered into the Hotel Phone App™ software system and Hotel Phone App™ QR codes specific to each hotel location/address are generated. These are then displayed on QR code display signs in hotel guest rooms. Hotel Phone App™ QR codes can only be recognized by using Hotel Phone App™ QR code scanners. Guests scan Hotel Phone App™ QR codes and instantly hotel phone, web, and navigation links appear on the screens of their cell phones. Hotel Phone App™ is currently available on both Apple and Google Play App stores.

In conjunction with Hotel Phone App™ services, hotels can maintain use of their existing VOIP and PBX phone services for business phones and other functions (e.g. front desk phones, managers office phones, administrative staff office phones, employee phones, fire alarm systems, etc.). Hotels can also maintain use of their existing hotel property management system software that coordinates hotel activities including employee functions and hotel guest services. This is an important advantage of Hotel Phone App™. Any replacement for hotel guest room phone systems must not interfere with hotels ability to maintain VOIP and PBX business/employee phone and property management systems.

### SUMMARY

Hotel Phone App™, when downloaded onto hotel guest cell phones and used with Hotel Phone App™ QR code display signs, provides a mobile cellular hotel communication system that has the same functionality as push button guest room phone systems. Additional functionality with hotel specific internet web links can also be added. Unlike current guest room push button phone systems which are cabled and limited to use in hotel guest rooms, Hotel Phone App™ can be used anywhere there is cellular reception, both inside and outside of hotel guest rooms. Further objects, features, advantages and properties of this cell phone application will become apparent in the detailed images and descriptions provided.

### BRIEF DESCRIPTION OF IMAGES

Hotel Phone App™ is currently available on Apple and Google Play App Stores. Because of this, actual images rather than drawings of the components of the system are provided.

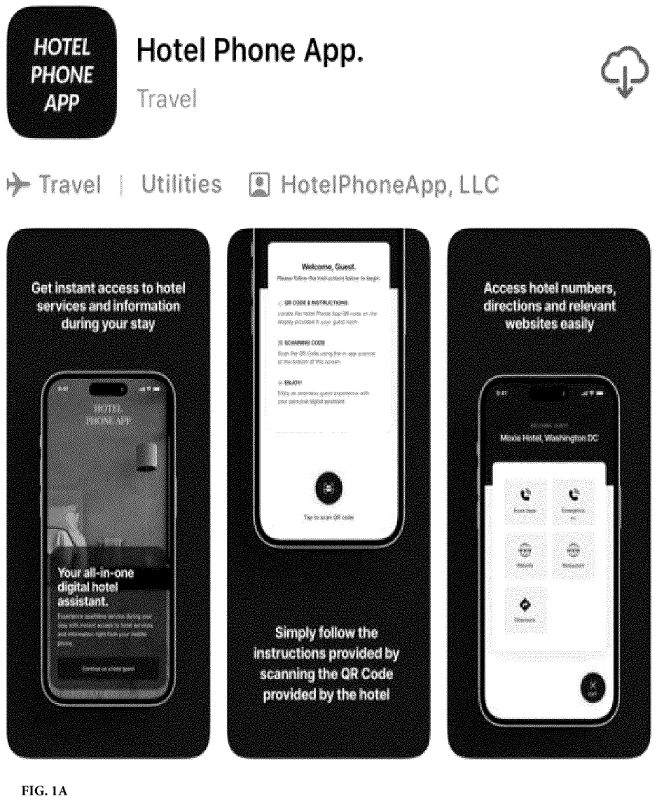

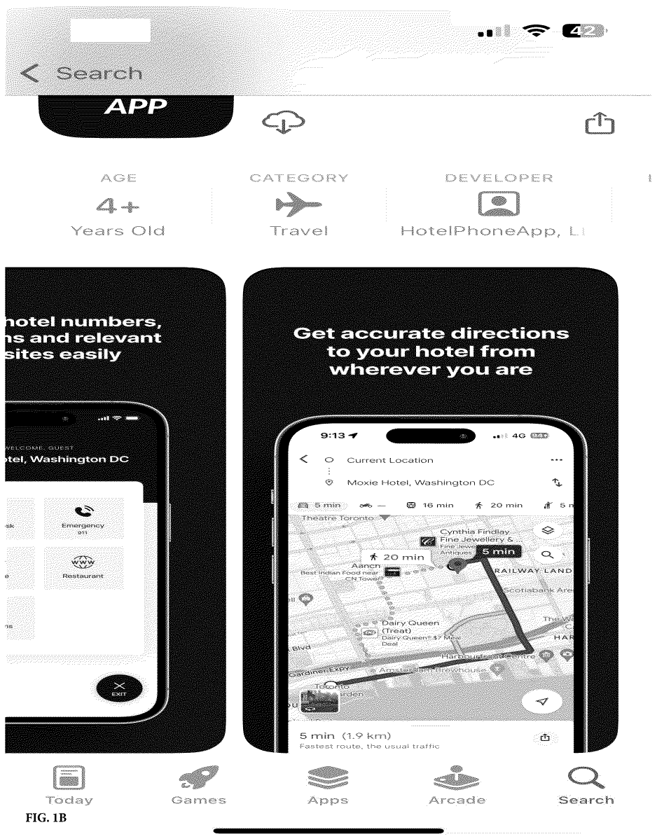

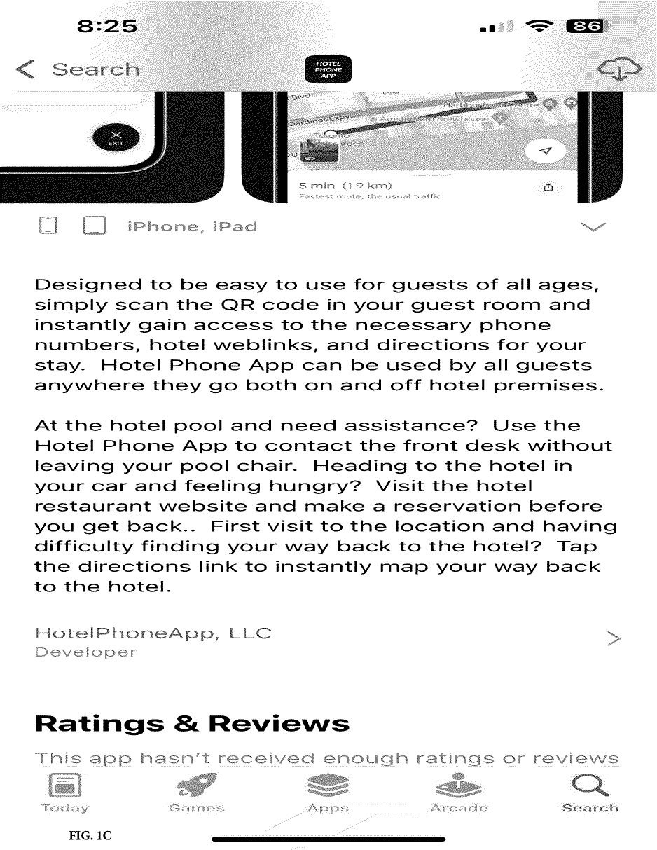

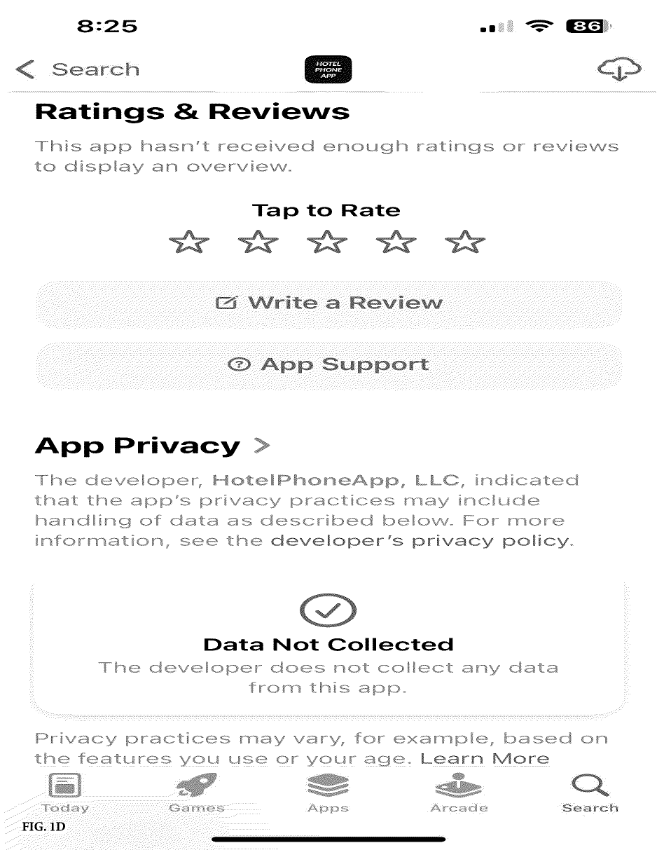

FIG. 1A Image of Hotel Phone App™ displayed on cell phone App Stores.

FIG. 1B Image of additional information displayed on cell phone App Stores.

FIG. 1C Image of additional information displayed on cell phone App Stores.

FIG. 1D Image of additional information displayed on cell phone App Stores.

FIG. 1E Image of additional information displayed on cell phone App Stores.

FIG. 2 Image of first hotel guest cell phone screen display after opening Hotel Phone App™.

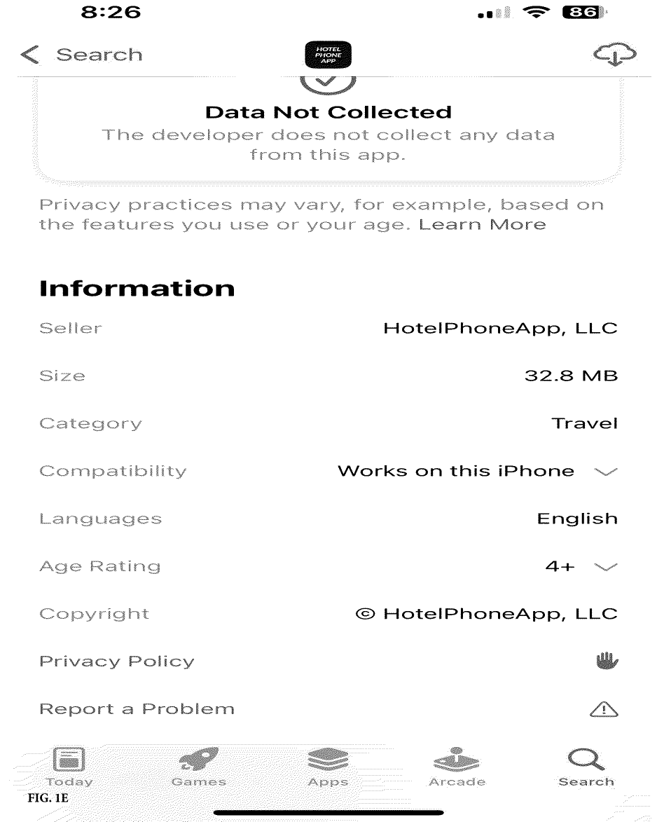

FIG. 3 Image of second cell phone screen display of the Hotel Phone App™.

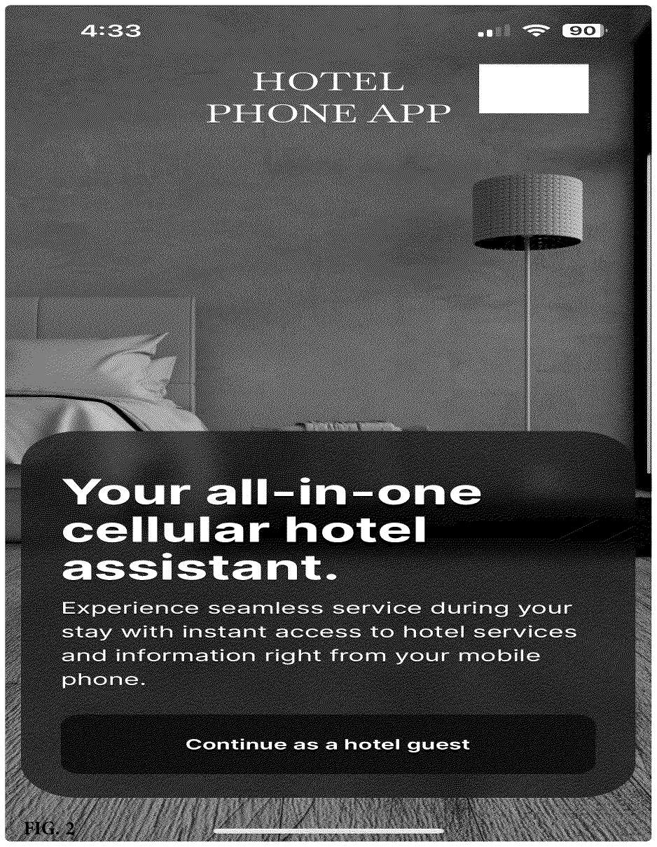

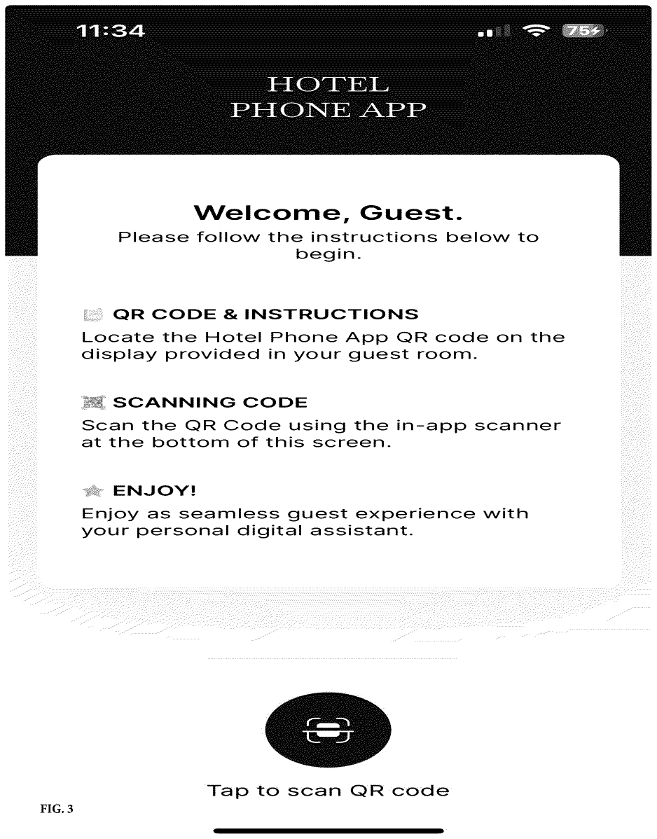

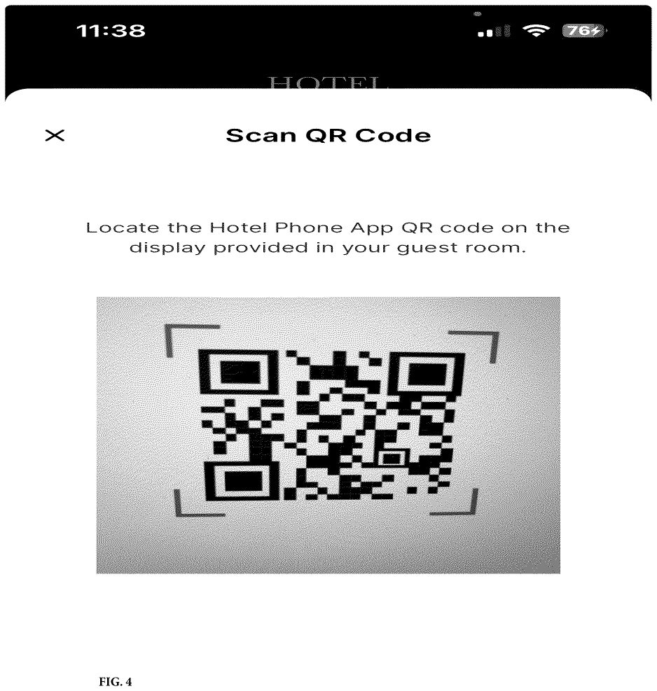

FIG. 4 Image of Hotel Phone App™ QR code scanner seen after tapping the QR code scanner icon displayed in FIG. 3.

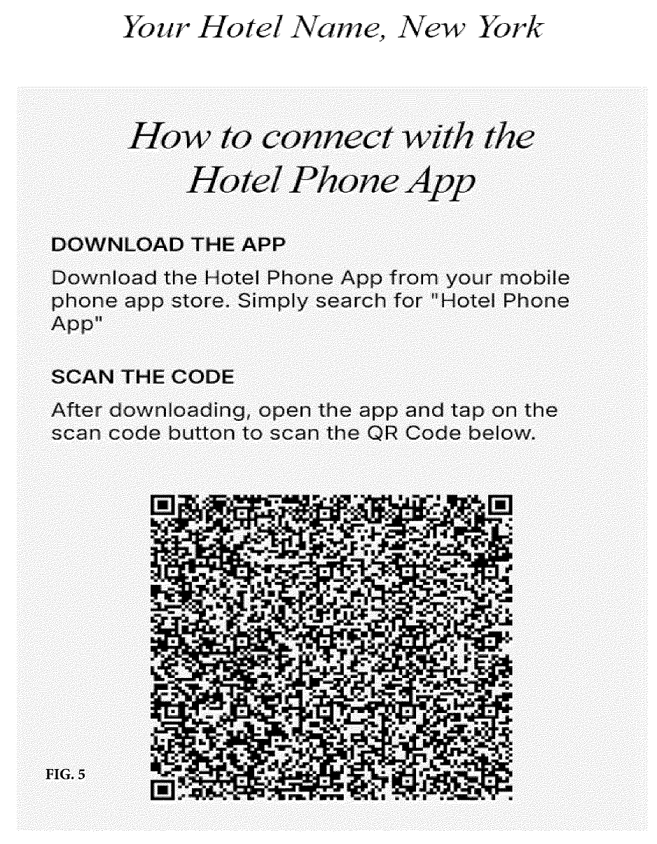

FIG. 5 Image of Hotel Phone App™ QR code specific to hotel location/address.

FIG. 6 Image of hotel guest cell phone screen display after scanning QR code.

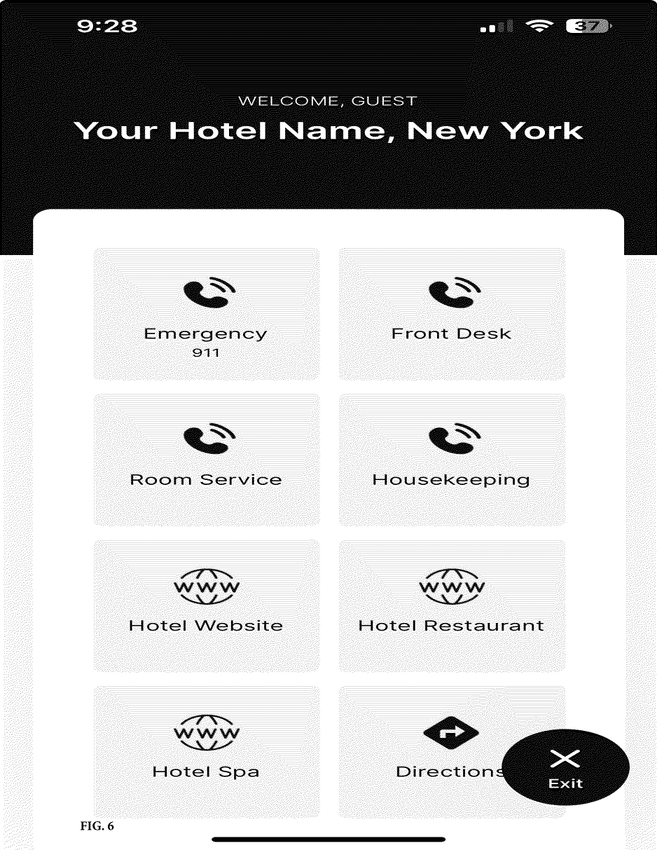

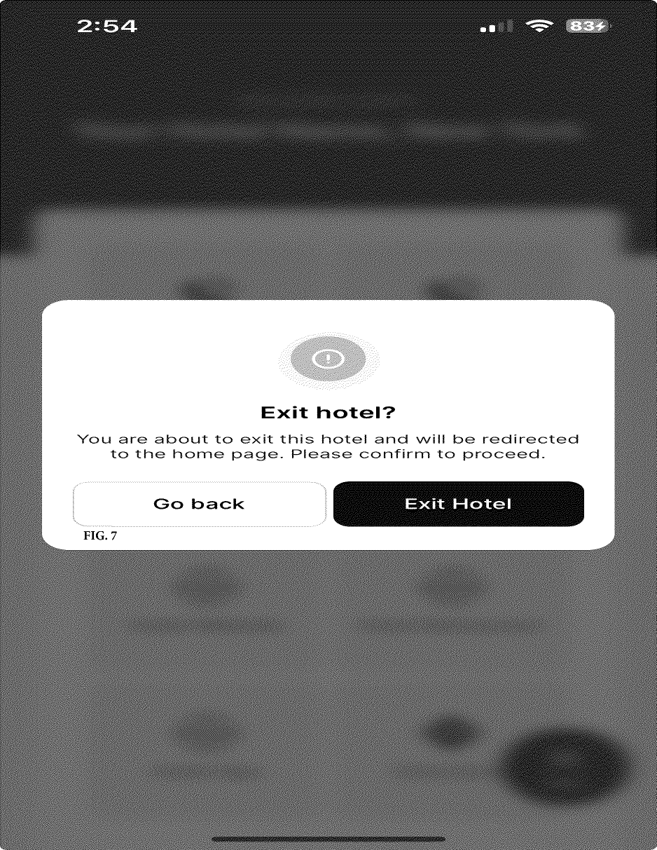

FIG. 7 Image of the final screen of Hotel Phone App™ when the hotel guest chooses to exit the application.

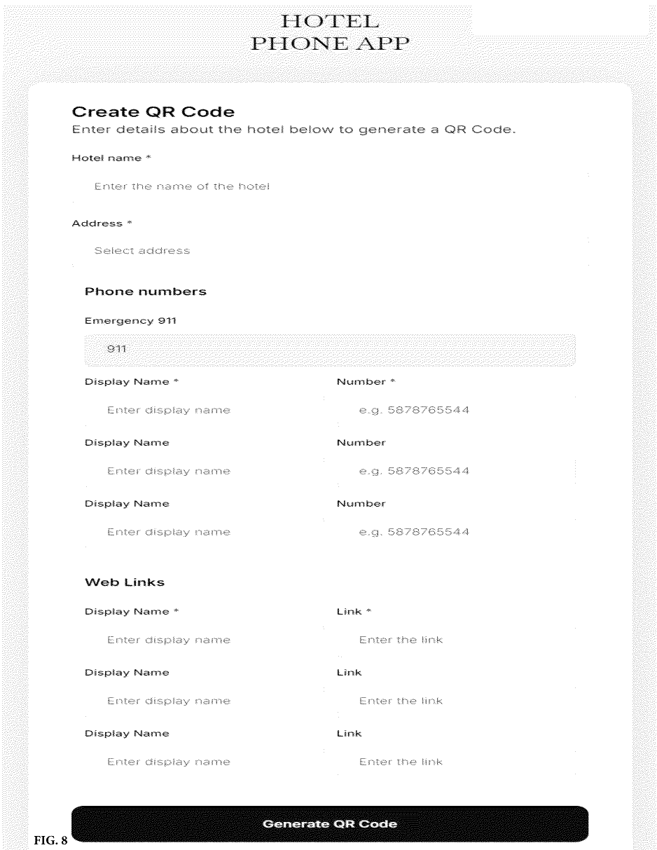

FIG. 8 Image of the homepage of Hotel Phone App™ QR code generator software which creates QR codes specific to each hotel location/address.

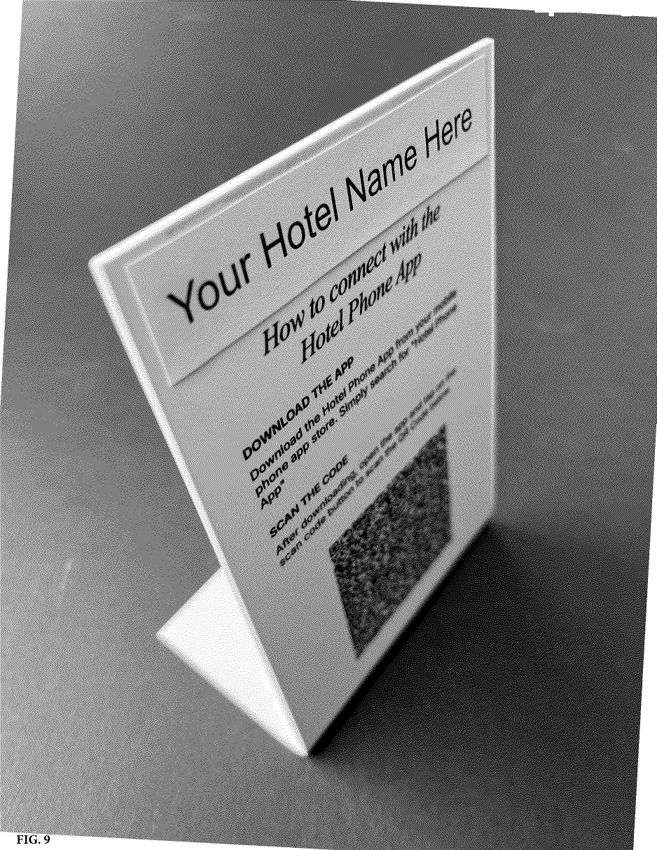

FIG. 9 Image of sample QR code display sign for hotel guest rooms (content details better visualized in FIG. 5).

### DETAILED DESCRIPTION

Listed below are detailed descriptions of images pertaining to the Hotel Phone App™ system.

FIG. 1A is an image of what hotel guests see after searching and locating Hotel Phone App on their cell phone App Stores. It contains an image of the blue Hotel Phone App™ icon and 3 images described in more detail in the figures below. Guests simply tap the download icon and Hotel Phone App™ loads onto their cell phones. The Hotel Phone App™ icon/link is then added to the hotel guest cell phone displays.

FIG. 1B is an image of additional information hotel guests see on their cell phone App Stores when they search and locate the App and then tap and enlarge the Hotel Phone App™ information image. It provides larger images of what is seen in FIG. 1A and also adds an image related to hotel directions. The image displayed provides an example of how the navigation software in the Hotel Phone App™ directs guests from wherever they may be located back to the hotel address. This enlarged view on the App Store also provides additional information seen in FIG. 1C, FIG. 1D, and FIG. 1E respectively when scrolling the content downward.

FIG. 1C is an image of additional information for Hotel Phone App™ provided on hotel guest cell phone App Stores. It is self-explanatory.

FIG. 1D is an image of additional information for Hotel Phone App™ provided on hotel guest cell phone App Stores. It is self-explanatory.

FIG. 1E is an image of additional information for Hotel Phone App™ provided on hotel guest cell phone App Stores. It is self-explanatory.

FIG. 2 is the first screen image seen by hotel guests after downloading and opening the Hotel Phone App icon/link on their cell phones. It is self-explanatory. Because the phone and web links on the Hotel Phone App™ are specific to their hotel locations it allows guest cell phones to function as “hotel assistants” providing guests with connectivity to a wide variety of services the hotel location has to offer by both phone and web links. The hotel guests tap “Continue as a hotel guest” to advance to the next screen image described in FIG. 3.

FIG. 3 is the second image hotel guests see on their cell phones. It is self-explanatory and provides a welcome and instructions. Hotel guests tap the blue QR code scanner icon at the bottom of the screen and the Hotel Phone App QR™ code scanning system appears as seen in FIG. 4.

FIG. 4 is an image of the Hotel Phone App™ QR code scanning system that operates using hotel guest cell phone cameras. Hotel guests focus their scanners on the Hotel Phone App™QR code displays located in their hotel rooms. Then the Hotel Phone App™ software creates the image seen in FIG. 6 on hotel guest cell phone screens.

FIG. 5 is an image of a Hotel Phone App™ QR code used on guest room Hotel Phone App™ QR code display signs. Instructions are provided which are self-explanatory.

Hotel Phone App™ QR codes can only be recognized by Hotel Phone App™ QR code scanners. They are not recognized by other QR code scanning software including the scanning software that comes pre-installed on guest cell phones.

FIG. 6 is the fourth image hotel guests see on their cell phones after scanning Hotel Phone App™ QR code display signs. It contains all of the phone, web and navigation links specific to hotel locations/addresses as a single image on hotel guest cell phone screens. All of the links are activated by tapping the cell phone touchscreen. A direct dial emergency 911 link is provided to contact local emergency response services.

Tapping the directions icon will provide routes for guests back to their hotel addresses. An exit icon is provided and tapped after guests check out of their hotels and no longer need Hotel Phone App™ service. The screen displayed in FIG. 6 stays active on hotel guest cell phones until they exit the application. The screen can be left open throughout hotel guest stays or can be closed and then reopened by tapping the Hotel Phone App™ icon on their cell phone displays.

FIG. 7 is the final image hotel guests see on their cell phones when they want to exit Hotel Phone App™. Its contents are self-explanatory. After the hotel guests exit, Hotel Phone App™ is reactivated to allow the scanning of Hotel Phone App™ QR codes at subsequent hotel locations.

FIG. 8 is an image of the homepage of software that generates location/address specific QR codes for hotels. The software is managed by Hotel Phone App™ administrators who work with hotel management to determine which links to install that are appropriate for their hotel locations. Hotel terminology for similar services varies by hotel, so the hotels also determine what to name the links on the cell phone displays. For instance, some hotels use the term “reception” rather than “front desk.”

FIG. 9 is an image of a guest room Hotel Phone App™ QR code display sign (details can be seen more clearly in FIG. 5).

The various aspects of what is described above can be used alone or in various combinations. The teaching of this application is not limited to cell phones, but can be equally well applied to any touch screen cellular device that can download applications from App Stores. The teaching of this application is not limited to hotel guests but can be equally well applied to other individuals (e.g. hotel staff, vendors, etc.). The teaching of this application is not limited to presentation of QR codes on guest room display signs, but can be equally applied to hotels sharing QR codes with guests using other mechanisms such as email or text prior to hotel guest arrival. The teaching of this application is not limited to a single type of QR code display sign, but could include any type of QR code display methodology. The teaching of this application is not limited to hotel guests' rooms, but could be equally applied to any location the hotel chooses to present the display signs. The teaching of this application is not limited to hotel specific QR codes, but could apply to hotel room specific QR codes (e.g. QR codes unique to each guest room). The teaching of this application is not limited to the content viewed as a single image on hotel guest cell phone displays but could also contain additional content, as previously described, seen by scrolling the image downward. The teaching of this application is not limited to hotel phone and web links but could include any weblinks hotels wish to choose. The teaching of this application is not limited to hotels, but could be applied to any business where there is a need to convert PBX or VOIP phone communication systems to mobile cellular technology with design features similar to Hotel Phone App™. The teaching of this application has numerous advantages. Different embodiments or implementations may yield one or more of the following advantages. It should be noted that this is not an exhaustive description of the advantages provided by Hotel Phone App™. Although the present application has been described in detail for the purpose of illustration, it is understood that such detail is provided solely for that purpose and variations can be made without departing from the scope of this application. It should also be noted that there are alternative ways of implementing the methods and apparatuses of the teaching of the present application. Features described in the preceding description may be used in combinations other than the combinations explicitly described. Regardless of emphasis placed, the applicant claims protection in respect to any patentable feature or combination of features referred to in the application and viewed in the figures provided.

1. A mobile cellular application software communication system which is customizable to individual hotel locations that replaces and further enhances the functionality of hotel guest room PBX/VOIP phone systems.

2. A software device according to claim 1, wherein the application provides location-specific hotel phone links for hotel services (e.g. front desk, room service, housekeeping, etc.)

3. A software device according to claim 1, wherein the application provides an Emergency 911 phone link for direct dial to emergency services.

4. A software device according to claim 1, wherein the application creates hotel location-specific QR code displays which when scanned activate the application software and guest cell phone displays.

5. A software device according to claim 1, wherein the application can be exited after hotel stays and reactivated for use at any hotel that has Hotel Phone App™ functionality with Hotel Phone App™ QR code display signs.

6. A software device according to claim 1, wherein hotel guests can have hotel guest room phone communication functionality that is mobile and not limited to guest rooms or hotel properties.

7. A software device according to claim 1, wherein hotel guest room push button PBX/VOIP phone systems can be replaced in a manner that allows hotels to maintain their existing PBX/VOIP business/employee phone and hotel property management systems.

8. A software device according to claim 1, wherein the application allows operability for any number of guests with cell phones staying in a single hotel guest room.

9. A software device according to claim 1, wherein hotel location-specific web links may be added to provide enhanced hotel service communication (e.g. hotel website link, hotel restaurant web link, hotel spa web link, etc.) 10. A software device according to claim 1, wherein a hotel location-specific direction navigation link is included to guide hotel guests to their hotel location addresses.
